(19) United States
(12) Patent Application Publication
(10) Pub. No.: US 2026/0002478 A1
(43) Pub. Date: Jan. 1, 2026

(54) HIGH PRESURE FUEL DELIVERY SYSTEMS IN AN OPPOSED PISTON ENGINE AND RELATED METHODS

(71) Applicant: Enginuity Power Systems, Inc., Alexandria, VA (US)

(72) Inventors: Philip Zoldak, Plymouth, MI (US); Andrew Harman, Lapeer, MI (US); Maysam Molana, Troy, MI (US); Philipp Schimmels, Royal Oak, MI (US)

(73) Assignee: Enginuity Power Systems, Inc., Alexandria, VA (US)

(21) Appl. No.: 19/196,247

(22) Filed: May 1, 2025

Related U.S. Application Data
(60) Provisional application No. 63/666,197, filed on Jun. 30, 2024.

(51) Int. Cl. F02D 1/08; F02D 41/38

(52) U.S. Cl. CPC F02D 1/08; F02D 41/3845; F02D 2001/085; F02D 2250/36; F02D 2250/38

(57) ABSTRACT

Innovative, high-pressure fuel systems and related methods are provided. Such systems and methods enable engines to use fuel more effectively.

### RELATED APPLICATIONS

This application claims priority to U.S. Provisional Application 63/666,197 filed Jun. 30, 2024 (the “197 Application”) and is related to 18/493,302 (the “'302Application”), U.S. patent application Ser. No. 17/696,834 (the “'834 Application), U.S. patent application Ser. No. 17/151,253 (the “253 Application”), PCT Application No. PCT/US2023/24939 (“'939 Application), co-pending U.S. Provisional Application ______ (sometimes referred to as the “ECU application”), co-pending U.S. Provisional Application ______ (sometimes referred to as the heated heavy fuel application) and co-pending U.S. Provisional Application ______ (sometimes referred to as the prechamber application). This application incorporates by reference in their entireties the disclosures of the '197, '302, '834, '253, '939 and all three co-pending applications (collectively “Related Applications”) as if such applications were set forth in full herein.

### GOVERNMENT RIGHTS

The inventive disclosures herein were made with U.S. government support under Contract Number W15P7T-19-D-0157 awarded by the United States Department of Defense. The U.S. government has certain rights in the inventive disclosures.

### TECHNICAL FIELD

This disclosure relates to small engines (e.g., <1.5 L/cylinder), such as inwardly opposed piston engines (OPEs), conventional in-line and vee-configuration engines that can operate under compression ignition using heavy fuels such as diesel, biodiesel, or Jet Propulsion (JP) 8 fuel, for example, at high pressures (e.g., greater than 200 bar).

### INTRODUCTION

This section introduces aspects that may help facilitate a better understanding of the disclosure. Accordingly, the statements of this section are to be read in this light and are not to be understood as admissions about what is, or what is not, prior art.

Conventional fuel systems typically employ mechanical pumps along with standard lines and fittings to pressurize and deliver fuel to a combustion chamber at lower pressures (e.g., below 200 bar). It is believed that increasing a fuel's pressure will increase the Reynolds number of the nozzle exit flow turbulence and may increase the efficiency and performance of the fuel delivered by fuel injectors. In theory, the increased pressure would result in increased liquid fuel break-up, droplet formation and promote mixing with air inside the combustion chamber which may yield beneficial combustion characteristics (e.g., increased thermal efficiencies and reduced emissions). However, there remains technical challenges to realize such benefits.

Accordingly, it is desirable to provide inventive solutions that allow for the use of increased fuel pressures to realize beneficial combustion in combustion engines (e.g., OPEs, and conventional internal combustion engines (ICEs).

### SUMMARY

The inventors describe various exemplary, inventive systems and related methods for increasing the pressure of a fuel to very high levels (e.g., 150 bar to 1000 bar) in order to yield beneficial combustion characteristics (e.g., increased efficiencies and reduced emissions). The inventors discovered that at elevated injection pressures, fuel liquid break-up, droplet formation and atomization is improved, leading to more effective fuel mixing with air. Additionally, by increasing the pressure of a fuel and then completing multiple injection events during a given cycle, the inventors discovered that the combustion heat release can be shaped to optimize key parameters, such as combustion noise, phasing, thermal efficiency, robustness, and constituent emissions of oxides of nitrogen (NOx) and unburned hydrocarbons (UHC) versus smoke emissions and torque. Further, the inventors discovered that this (i) facilitated an increase in droplet vaporization, thus enhancing mixing with air and combustion and thermal efficiency while (ii) avoiding wall wetting and (iii) reducing emissions and improving engine durability with middle distillates fuel such as JP8. Improved fuel air mixing avoids the common problem of wall wetting of heavy fuels & kerosene type fuels. Wall wetting causes oil dilution with fuel and this reduces engine oils viscosity and leads to engine failure.

In one embodiment this disclosure describes an inventive electronically controlled, solenoid valve fuel pump that provides minimal mechanical losses compared to existing or conventional mechanical pumps, The inventive pump may be sized for use in small engines, such as an OPE or a conventional ICE. The inventive pump enables the delivery of fuel at pressures to an inventive fuel rail that are at, or near, setpoint pressures without having to overpressure. An inventive pressure relief valve is included to bleed off excessive pressure.

The inventive fuel rail may be hydraulically optimized via simulations to minimize pressure wave dynamics thus enabling multiple injection events and heat release rates which have the additional benefit of avoiding high combustion noise that are common in existing, mechanical pumps/mechanical injector used in small diesel engines.

The elements above form an inventive system that provides inventive heat release shaping that allows strategies to be used in smaller diesel engines more efficiently and effectively.

As described in more detail herein, embodiments of the disclosure focus on regulating the inlet flow to a fuel pump electronically to limit both fuel flowrate and reducing the pumping work required by the pump to attain a given fuel pressure prior to delivery to a fuel rail. The fuel rail functions as a pressure buffer for the electronic fuel injectors to enable multiple injections. The inventors discovered that this improves combustion performance and reduces the required mechanical work required versus conventional diesel common rail systems.

More particularly, one embodiment of a method for providing high pressure fuel delivery for an engine may comprise: increasing pressure of a fuel to a range of 150 bar to 1000 bar to yield increased efficiencies and reduced emissions utilizing one or more elements of a high pressure fuel delivery system. Further such a method may comprise one or more of the following steps: increasing the Reynolds number to provide improved fuel nozzle exit velocity utilizing the one or more elements of the high pressure fuel delivery system; effectively breaking up molecules of the fuel and improving subsequent droplet vaporization and mixing with air to provide a better diffusion burn mixture utilizing the one or more elements of the high pressure fuel delivery system; completing multiple fuel injection events during an engine cycle utilizing the one or more elements of the high pressure fuel delivery system; providing shaped combustion heat releases to optimize combustion noise, durability, NOx versus smoke emissions and torque utilizing the one or more elements of the high pressure fuel delivery system; increasing the droplet vaporization to enhance mixing with air and combustion and thermal efficiency while avoiding wall wetting as well as reducing emissions utilizing the one or more elements of the high pressure fuel delivery system.

The one or more elements in such an exemplary method may comprise at least an electronically controlled, solenoid inlet valve fuel pump configured to regulate fuel flow to meet a fuel rail pressure target and minimize mechanical losses, where the pump may be configured and sized for an engine with less than 1.5 L displacement (e.g., inwardly opposed piston engine). In an embodiment, the pump may be configured to deliver the fuel at pressures to a fuel rail at or near setpoint pressures without having to overpressure to meet the fuel rail pressure target.

The one or more elements of the exemplary method may yet further comprise (i) an inlet solenoid valve that minimizes the amount of fuel rail pressure overshoot; (ii) a pressure relief valve and a rail pressure sensor that fine tunes the fuel rail pressure; and a fuel rail (e.g., a hydraulically optimized fuel rail).

Still further, the method may further comprise minimizing pressure wave dynamics to enable multiple injection events and combustion heat release rates to avoid high combustion noise and assist in meeting smoke and NOx emission targets utilizing the hydraulically optimized fuel rail, and providing heat release shaping utilizing the one or more elements of the high pressure fuel delivery system.

In an embodiment, the one or more elements may again comprise a fuel pump and a fuel rail, wherein the method may comprise regulating an inlet flow to the fuel pump electronically to limit both fuel flowrate and fuel pressure prior to delivery to the fuel rail.

The one or more elements of the method may comprise one or more electronic fuel injectors, wherein a fuel rail is configured to provide a pressure buffer with respect to the one or more electronic fuel injectors to enable multiple injections to improve a fuel injection process and overall combustion performance of the engine.

In addition to inventive methods, the inventors also provide inventive systems.

One such system may provide high pressure fuel delivery for an engine, where the system may comprise one or more elements and the one or more elements may increase a pressure of a fuel to a range of 150 bar to 1000 bar in order to yield increased efficiencies and reduced emissions.

In such an exemplary system the one or more elements may comprise (i) an inlet solenoid valve that minimizes the amount of fuel rail pressure overshoot; (ii) a pressure relief valve and a rail pressure sensor that fine tunes the fuel rail pressure; (iii) a hydraulically optimized fuel rail configured to minimize pressure wave dynamics to enable multiple injection events and combustion heat release rates to avoid high combustion noise and assist in meeting smoke and NOx emission targets; (iv) a fuel pump and one or more electronic fuel injectors, wherein the fuel rail may be further configured to provide a pressure buffer with respect to the one or more electronic fuel injectors to enable multiple injections to improve a fuel injection process and overall combustion performance of the engine.

The inventive methods and corresponding systems described above are just some of the inventive systems and methods that will be apparent from the disclosure herein.

### BRIEF DESCRIPTION OF THE DRAWINGS

The present invention is illustrated by way of example and is not limited by the accompanying figures in which like reference numerals indicate similar elements and in which:

FIG. 1 depicts an exemplary OPE according to one embodiment of the present disclosure.

FIG. 2A depicts a view of an exemplary electronically controlled fuel pump according to one embodiment of the present disclosure.

FIG. 2B depicts another exemplary electronically controlled fuel pump according to one embodiment of the present disclosure.

FIGS. 3 and 4 depict an exemplary OPE with views of components positioned on the high-pressure side of the exemplary electronically controlled fuel pump according to one embodiment of the present disclosure.

FIGS. 5A through 5E depict a comparison between an existing fuel rail and an inventive fuel rail according to embodiments of the present disclosure.

FIG. 6 depicts an exemplary view of an exemplary fast-acting fuel injector system according to an embodiment of the present disclosure.

FIGS. 7A to 7D depict graphs illustrating experimental results of fuel injector, rate of injection measurements according to embodiments of the present disclosure. FIG. 7E depicts a graph of fuel injected volume versus fuel injection time while FIG. 7F depicts the experimental set-up used to generate the graphs in FIGS. 7A to 7E.

Specific embodiments of the present invention are disclosed below with reference to various figures and sketches. Both the description and the illustrations have been drafted with the intent to enhance understanding. For example, the dimensions of some of the elements in the figures may be exaggerated relative to other elements, and well-known elements that are beneficial or even necessary to a commercially successful implementation may not be depicted so that a less obstructed and a clearer presentation of embodiments may be achieved.

Simplicity and clarity in both illustration and description are sought to effectively enable a person of skill in the art to make, use, and best practice the present invention in view of what is already known in the art. One skilled in the art will appreciate that various modifications and changes may be made to the specific embodiments described herein without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EXEMPLARY EMBODIMENTS

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

As used herein and in the appended claims, the term “comprises,” “comprising,” or variations thereof are intended to refer to a non-exclusive inclusion, such that a process, method, article of manufacture, or apparatus (e.g., an OPE) that comprises a list of elements does not include only those elements in the list, but may include other elements not expressly listed or inherent to such process, method, article of manufacture, or apparatus.

The terms “a” or “an,” as used herein, are defined as one, or more than one. The term “plurality,” as used herein, is defined as two, or more than two. The term “another,” as used herein, is defined as at least a second or more.

Unless otherwise indicated herein, the use of relational terms, if any, such as “first” and “second”, “top” and “bottom”, “back” and “front”, and “left” and “right” and the like are used solely to distinguish one view, entity or action from another view, entity or action without necessarily requiring or implying any actual such relationship, order or importance between such views, entities or actions.

The terms “including” and/or “having,” as used herein, are defined as comprising (i.e., open language).

As used herein “x-axis” or “first axis,” “y-axis” or “second axis” and “z-axis” or “third axis” mean three different geometric directions and planes.

To the extent any dimension, weight, size, percentages, or operating parameters are described herein or shown in the figures (collectively “parameters”), it should be understood that such parameters are non-limiting and merely exemplary to allow those skilled in the art to understand the inventive embodiments described herein.

Similar reference numbers may denote similar components and/or features throughout the attached drawings.

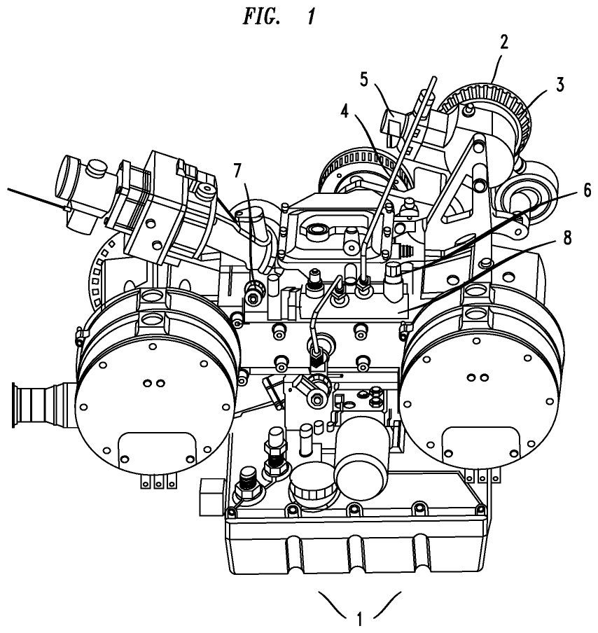

Referring to FIG. 1 there is depicted an exemplary OPE 1 according to the disclosure. The OPE 1 may be configured to operate using both gaseous and/or liquid fuel (e.g., diesel, biodiesel, JP-8, or F-24 (NATO equivalent) or Fisher-Tropsch fuels). OPE 1 may operate using one or more combustion modes, such as controlled compression ignition or diffusion flame combustion, partially premixed combustion compression ignition (PPCI) or gasoline direct-injection compression-ignition (GCI), or spark ignition (SI) for example.

The opposed, inwardly facing pistons (not shown) of the OPE 1 may have predetermined lengths and predetermined diameters. In one embodiment, the stroke length of each of the opposed pistons may be twice the amount of a conventional engine, for example, it being understood that the piston lengths may be geometrically determined in accordance with the piston stroke length and the lengths of apertures formed in a wall of the cylinders through which flow exhaust gases and air for combustion (e.g., see element 5a in FIG. 3C of the '253 Application). Thus, the total difference between the spacing of the pistons at closest approach to each other (i.e., at “top dead center”) and the maximum spacing of the pistons during the engine cycle (i.e., at “bottom dead center”) may also be twice the amount of a conventional engine, for example.

As shown in FIG. 1, OPE 1 may include an electronically-controlled fuel pump 2 (e.g., pulley-driven fuel pump or an intake/exhaust cam driven pump), fuel pump cam housing 3, one or more high pressure fuel lines 4, one or more low pressure fuel inlets 5, one or more pressure sensors 6, one or more pressure relief valves 7, one or more fuel rails 8 that may be bolted to the engine's housing, and one or more fuel injectors 9 (see FIG. 3). As explained in more detail herein, the pump 2 may be configured to increase the pressure of the fuel (e.g., JP8) to 200 bars or more and deliver the fuel at a desired flow rate and fuel pressure to the injectors 9 via the high pressure fuel lines 4.

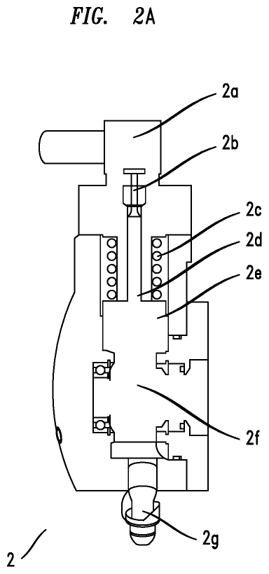

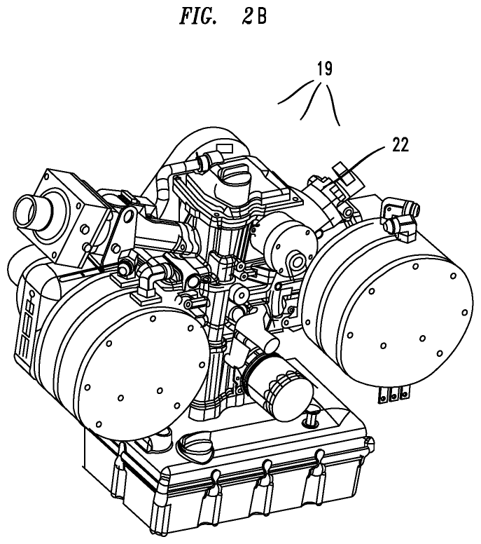

In an embodiment, the OPE 1 may operate as follows. Fuel may be delivered from a fuel tank (not shown) to the fuel pump 2 after the fuel passes through one or more fuel filters (not shown). Referring now to FIG. 2 there is depicted an exemplary, electronically controlled fuel pump 2.

In an embodiment, the fuel pump 2 may be installed in a stand-alone pump housing with a rotary pulley or gear driven, two-lobe camshaft located inside the pump housing that has an oil lubrication system tied into the engine oil lubrication system.

When the pump 2 comprises a solenoid-type configuration, such a pump may comprise a solenoid 2a solenoid valve 2b, plunger spring 2c, plunger 2d, cam follower 2e, single or multi-lobe pump cam 2f (e.g., 2-lobes) one or more oil drains 2g and retainer 2h (see FIG. 3).

The pump may further comprise an inlet 2i (see FIG. 3) that receives the filtered fuel. The fuel pump 2 may be configured to regulate the flow of the fuel (again, JP8 fuel for example) from a low pressure side of pump 2 at the inlet 2i into the plunger spring and plunger combination 2c,2d. In an embodiment, the solenoid and solenoid valve combination 2a,2b may be connected to an electronic control unit

(ECU) such as the ECU described in co-pending U.S. Application (not shown) that sends electronic signals to the combination 2a, 2b in order to control the operation of the pump 2 (e.g., solenoid combination 2a, 2b).

For example, in one embodiment an electronic signal may be sent from the control system to the solenoid combination 2a,2b that causes the solenoid valve 2b to be forced against the plunger 2d to open the inlet 2i to the pump 2 to allow fuel to flow through the pump 2 while another signal may cause the solenoid valve 2b to be released from the plunger 2d whereupon the spring 2c forces the valve 2b away from the plunger 2d to close the inlet 2i thereby preventing fuel from flowing through the pump 2. In effect then, the signals received by the pump 2 cause the pump 2 to control the opening and closing of the pump's inlet 2i. In an embodiment, the pulse width of this signal may be used to control the amount of fuel flowing through the pump 2. In an embodiment, the control system may be configured to send an electronic signal to the pump 2 that causes the pump 2 to allow a threshold amount of fuel to pass through the pump 2 in order to operate the OPE 1 at a desired engine speed and load point. In an embodiment the fuel pump 2 may be configured to increase the pressure of the fuel from an initial pressure of 2 bar up to a maximum value of 1000 bar.

The inventors believe that the use of an electronically controlled fuel pump 2 configured as disclosed herein decreases the mechanical work needed to pressurize the fuel (when compared to existing engines whose pumps are mechanically driven) while simultaneously increasing the mechanical efficiency of the pump 2 (i.e., improves the ability of the OPE 1 to convert a higher percentage of energy from the fuel into useful work (Brake Thermal Efficiency)).

The inventors also believe that the inventive fuel rails configured as described herein improve the pressure wave dynamics, and fuel quantity delivery control during a multiple injection event strategy and thus helps improve the robustness of the fuel delivery control during rapid succession injection events. Thus the benefits of heat release shaping can be realized for purposes of minimizing both combustion noise and fuel wall wetting which minimizes fuel consumption and improves engine durability, reliability and usefulness to applications which are noise sensitive.

FIG. 2B depicts an exemplary, alternative configuration of a fuel pump 22 installed in the upper intake cam housing of an OPE 1a. In this embodiment the pump comprises a two-lobe cam along with the intake cam-shaft of the engine 1a. The pump 22 may be driven by the same drivetrain as the intake valve and receive splash lubrication since it is located inside the intake cam housing. The pump 22 may also be controlled by an ECU, such as the ECU described in co-pending U.S. Application ______. Hereafter, reference to pump 2 is intended to include pump 22 and reference to engine 1 is also intended to include engine 1a unless stated otherwise or as is apparent from the context of the description herein.

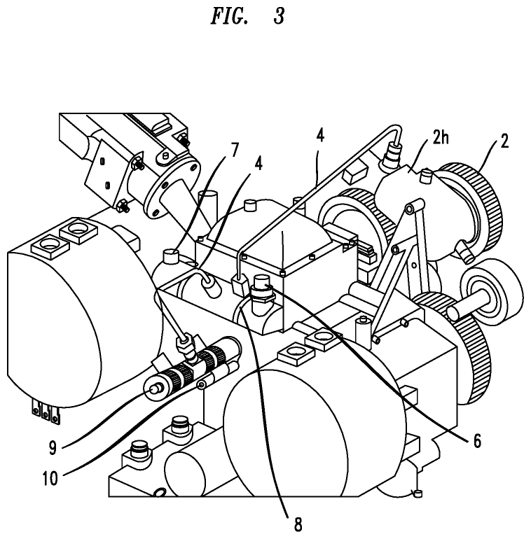

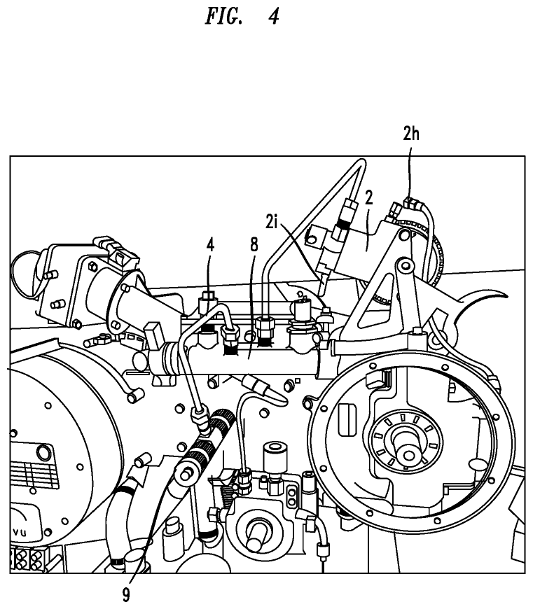

Referring now to FIGS. 3 and 4 there is shown the OPE 1 with views of components positioned on the high-pressure side of the pump 2.

Focusing on FIG. 3, pressurized fuel from the pump 2 may be sent to the high-pressure fuel rail 8. In an embodiment the rail 8 is configured to maintain the pressure of the fuel and then provide pressurized fuel to the one or more injectors 9.

In an embodiment the rail 8 may function as a fuel pressure reservoir or buffer that may be positioned close to a fast-acting electronically controlled injector, such as injector 9. The rail 8 may be configured to be hydraulically optimized (e.g., via simulations) to minimize issues with pressure wave dynamics. It should be noted that nominally for small CI engines no fuel rail is typically utilized. Further, the use of the inventive rail eliminates or substantially minimizes the need to use large L/D ratio tubes which are typically used to connect an injector to the outlet of a pump.

Yet further, the rail 8 may be configured to regulate the pressure of the fuel by, for example, incorporating a fuel pressure sensor and pressure relief valve in addition to functioning as a fuel pressure buffer or ballast. For example, the fuel pump 2 may deliver fuel to the fuel rail 8 at a fuel pressure set-point prescribed by an ECU (e.g., the ECU set forth in co-pending U.S. Patent Application No. _______). The fuel pressure sensor 6 may measure the fuel pressure in the rail 8 and if the set point is exceeded the ECU commands the pressure relief valve 7 (i.e., sends electronic instructions to) to open to decrease the pressure in the rail 8. In embodiments, a stable fuel pressure in the fuel rail 8 along with optimized hydraulic dynamics, enables multiple close-coupled high pressure injection events to occur during a given combustion cycle.

In an embodiment, the pressure sensor 6 may be configured to provide feedback to the fuel pump 2 by detecting the fuel pressure of the rail 8 and providing an electronic signal representing the detected fuel to an ECU, such as the ECU described in co-pending U.S. Application ______, (not shown). In an embodiment, the ECU may be configured (e.g., programmed with stored electronic instructions) to monitor and control the amount of pressurized fuel allowed to enter the fuel rail 8 in order to regulate (i.e., allow or prevent) the amount of fuel in the rail 8 to an amount substantially equal to just above a pre-set fuel pressure setpoint that may be stored within the electronic instructions of the ECU (e.g., a PID control parameter calibratable within the ECU).

In an embodiment, if the fuel pressure in the rail 8 is detected by the combination of the sensor 6 and ECU to exceed greater than 50 bar above a setpoint, then the pressure relief valve 7 may be configured to open to quickly release the fuel pressure in the rail 8 and restore the pressure to the amount associated with the set-point. Thus, the fuel pressure and fuel flow of the fuel in the rail 8 can be controlled to ensure an amount of fuel that can be safely stored in the rail 8. In more detail, the sensor 6 or ECU may optionally send an electronic signal to the relief valve 7 to open the valve in order to release pressure within the rail 8. In an embodiment, the combination of the pressure sensor 6 and relief valve 7 may be configured to reach adjust and maintain a desired fuel pressure.

In an embodiment, controlling the pressure in the rail 8 is useful in many instances other than high pressure conditions. For example, it may be necessary to increase the pressure in one or more of the cylinders of the OPE 1 during a so-called cold start of the OPE 1, especially in cold weather or when the OPE 1 has not been operated in a while.

Still further, the rail 8 may be configured to regulate the pressure of the fuel by functioning as a ballast with a buffer volume of fuel in order to allow for close coupled fuel injections and a desired heat release shape (i.e., the pattern or profile of how heat is released during combustion).

For the reader's benefit, heat release “shaping” may optimize a particular speed and load point of an engine (e.g., OPE 1) to minimize or reduce combustion noise, anti-wall wetting, and unwanted emissions (e.g., NOx, hydrocarbons, and carbon monoxide)

Continuing, after fuel passes through the pump 2 and rail 8 at a desired high-pressure it may be directed to one or more fuel injectors 9 via high-pressure fuel line 4. In an embodiment, the combination of the pump 2, rail 8, pressure sensor 6, relief valve 7 and line 4 may be configured as disclosed herein to control the pressure of the fuel that is delivered to the fuel injectors 9. In particular, such a combination of components may be configured to control the pressure of the fuel that is delivered to the fuel injectors 9 to within 5% of a desired value.

Though only a single fuel injector 9 is depicted in FIG. 3 it should be understood that more than one fuel injector may be used. For example, in one embodiment the fuel may be fed to separate fuel injectors by splitting the fuel line 4 into two branches, each branch feeding a separate injector and its corresponding separate cylinder. In an embodiment one of the fuel injectors may be direct fuel injector (DI). The DI injector may comprise an electronically actuated solenoid configured to control the injection of the fuel at a high rate of injection. Further, the DI injector may be configured to inject substantially 100% of the fuel when required which is believed to induce a high fuel penetration rate of the fuel into the combustion chamber to enable a combination of controlled compression ignition or diffusion flame combustion.

If desired, excess, or unused fuel may be routed from the back of an injector to the fuel tank (not shown) by means of a low pressure return line (not shown). In an embodiment, the low pressure return lines may be connected to the injector 9, pressure relief valve 7 and the fuel rail 8.

FIG. 3 also depicts one or more exemplary injector tie downs 10 that may be configured to securely connect the fuel injectors 9 to the OPE 1 (e.g., to the fuel rail 8).

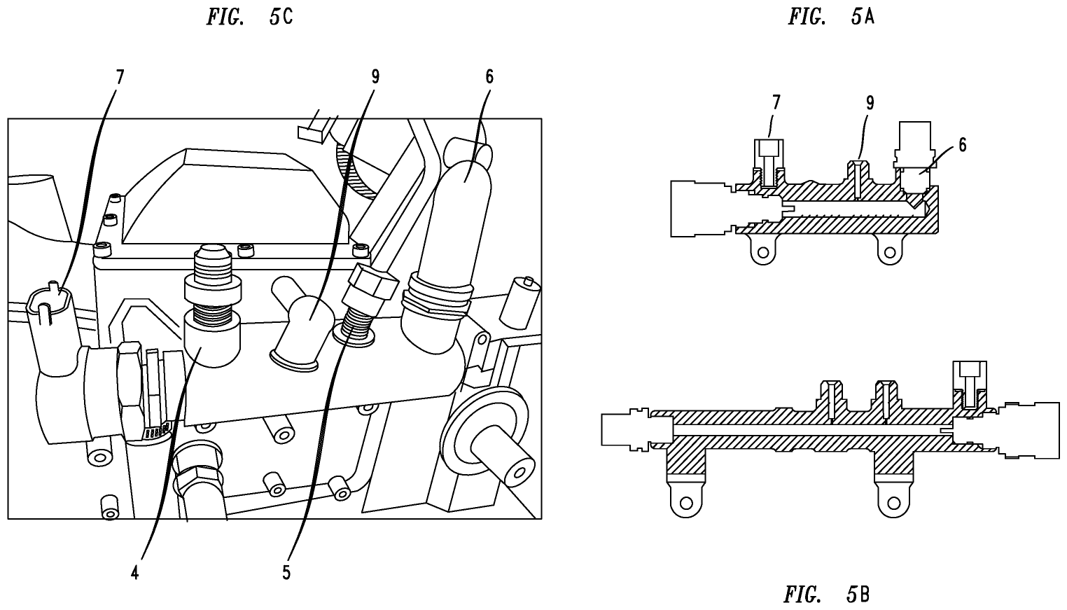

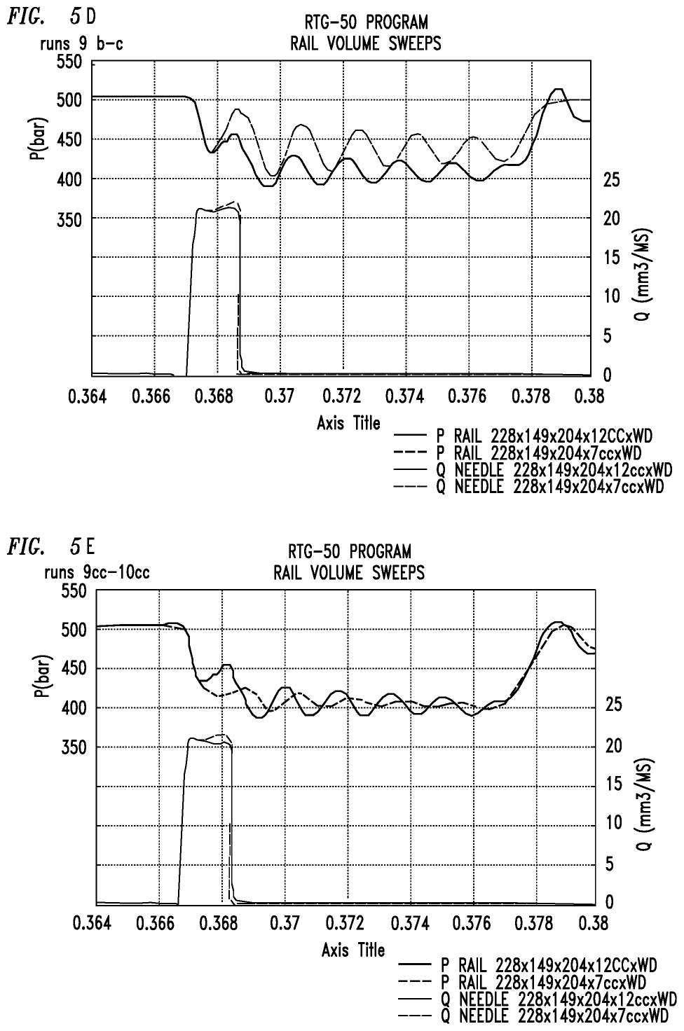

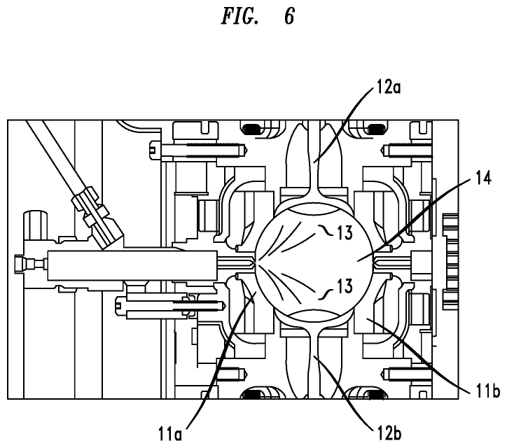

Referring now to FIGS. 5A to 5E there is illustrated a comparison between an existing fuel rail and the inventive fuel rail 8 according to embodiments of the present disclosure.

FIG. 5A depicts an existing fuel rail while FIG. 5B depicts the exemplary, inventive fuel rail 8. As can be seen, the inventive fuel rail 8 of FIG. 5B is substantially shorter in length than the existing fuel rail in FIG. 5A. In an embodiment, the inventive fuel rail may be 2.1 inches shorter than an existing rail. Such a shorter fuel rail enables the prevention of excessive over-hang in a side mount configuration of an OPS4 engine, so the rail does not overhang. In an embodiment, the volume of the inventive fuel rail 8 may be configured to accommodate (i.e., enable) a plurality of three simultaneous injections by three injectors (e.g., of JP-8 fuel).

FIG. 5C depicts an image of the exemplary, experimental fuel rail 8.

Referring now to FIGS. 5D and 5E there are depicted graphs that compare the fuel pressure (y-axis) versus volume (i.e., fuel volume, x-axis) of an existing fuel rail (FIG. 5D) versus the exemplary, shorter-in-length fuel rail 8. Based on a comparison of the two graphs the inventors discovered that upon using the same pulse width (i.e., the time allowed to inject fuel) that the shorter, inventive exemplary fuel rail 8 in FIGS. 5B and 5C provided an increase in fuel pressure stability and an increase in fuel pressure control for a given volume when compared to the existing rail in FIG. 5A, where, typically, the fuel pressure of the existing rail may fluctuate widely or uncontrollably.

For the reader's benefit, stability of the pressure of the fuel in the fuel rail 8 becomes important during multiple, close-coupled injection events in order to insure that the second and higher number of events have a sufficient fuel pressure during the injection event, since the fuel rail is up-stream of the injector 9 and is connected to the injector 9 via a short fuel line 4 (e.g., 8 inches).

Ensuring that the inventive fuel rail 8 provides stable fuel pressures allows for more predictable fuel flow rates per a given injection which leads to more useful, heat release shaping (e.g., reduces combustion noise, wall wetting and minimizes fuel consumption).

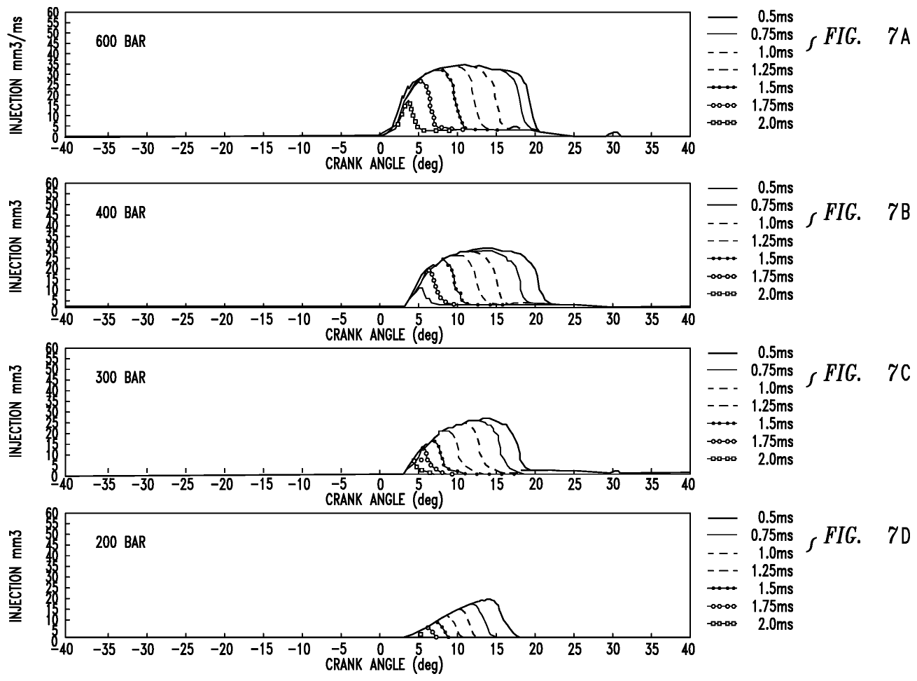

Referring now to FIG. 6 there are illustrated an exemplary view of an exemplary fuel injector 9a, such as a DI injector. In FIG. 6, the configuration of an exemplary DI injector 9a (that may include fuel jet channels 13) with respect to inwardly opposed pistons 11a, 11b may be optimized using Finite Element Analysis (FEA) with respect to its nozzle (i.e., the angle of a fuel passage within an inventive nozzle of an inventive fuel injector may be increased to 22 degrees, for example, such that the fuel passage angle is spaced “away” from a needle bearing).

FIG. 6 also depicts intake and exhaust valves 12a,12b. It should be understood that the direct injector (DI) 9a may be one of the injectors 9 illustrated in FIGS. 1 and 3 and discussed elsewhere herein.

As noted previously, fuel (e.g., JP-8) may be injected into the combustion chamber 14 and form a spray pattern 13 using a DI 9a that comprises an electronically actuated solenoid that delivers the fuel into the chamber 14 at a high rate of injection. For example, in one embodiment fuel may be injected by DI 9a at pressures from 150 bar up to 1000 bar which enables a plurality of combustion modes including controlled compression ignition (MCCI) or diffusion flame combustion, partially premixed compression ignition (PPCI), gasoline compression ignition (GCI) and conventional spark ignition (SI) combustion strategies.

Upon being injected into the combustion chamber 14 by the DI injector 9a, the fuel may be directed to flow within fuel jet channels of the pistons 13. In embodiments, the channels may comprise half jet channels that are cut-out from the pistons 11a, 11b. These channels are configured to guide the injected fuel and allow the fuel to effectively mix with air in the chamber 14. In an embodiment, during operation of the OPE 1, and as the two inwardly opposed pistons 11a, 11b come close to one another, the respective half jet channels (or cut outs) may form a circular jet cutout, for example. The geometries of the internal channels of the DI injector 9a may be configured in accordance with FEA studies and may be further optimized depending on requirements and boundary conditions of an engine (e.g., engine 1) (i.e., the. angle of a fuel passage within an inventive nozzle of an inventive fuel injector may be increased to 22 degrees, for example, such that the fuel passage angle is spaced “away” from a needle bearing).

The inventors believe that the compactness of the DI injector 9a is inventive. In more detail, many existing DI injectors that include solenoid actuators are substantially longer than the inventive DI injector 9a. Inventively, the DI injector 9a is substantially shorter in length than existing injectors (e.g., 4 inches, or more than 2 inches shorter in length). Further, such a DI injector 9a can complete multiple, smaller injections (up to five injections) per engine cycle which provides a substantial improvement over existing mechanical DI injectors that can typically only provide one injection per engine cycle.

The inventors also note that because the DI injector 9a comprises its own solenoid actuator, it is not reliant upon the timing of the opening and closing of the solenoid in the pump such as is common with existing, mechanical fuel injection systems 2 to inject fuel from the pump 2 into the combustion chamber 14. Said another way, the DI injector 9a is independently actuated from the pump 2. Accordingly, the inventive engine 1 offers advantages over existing small CI engines which are reliant upon the timing of mechanical unit pumps and fuel delivery valves which effectively limit injections to a single injection.

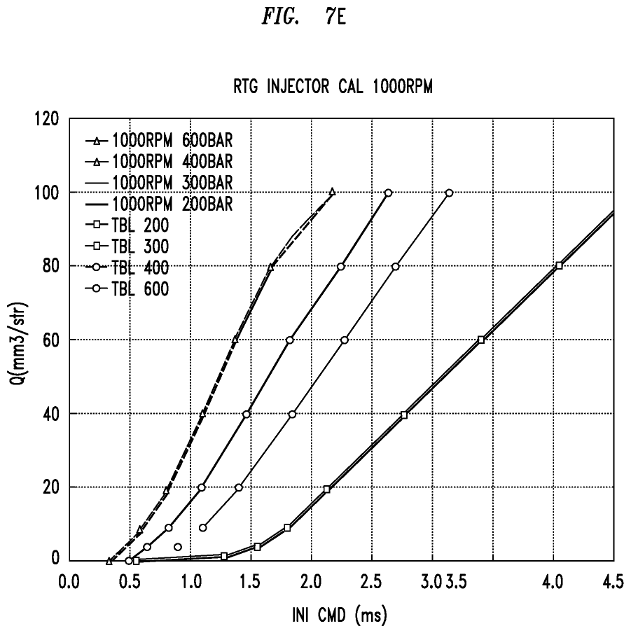

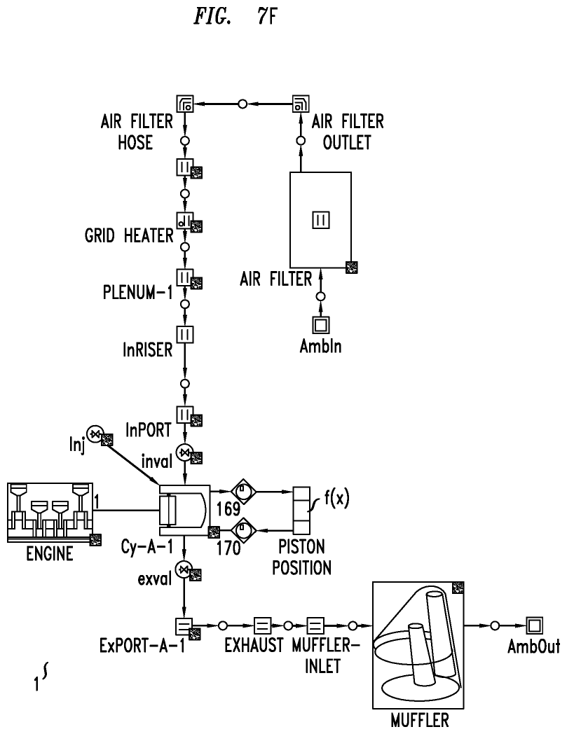

FIGS. 7A to 7D depict graphs illustrating experimental rate of injection (ROI) measurements for the exemplary, inventive DI fuel injector 9a according to embodiments of the present disclosure. FIG. 7E depicts a graph of fuel volume versus fuel injection time, while FIG. 7F depicts the experimental set-up used to generate the graphs in FIGS. 7A to 7E.

As shown, the ROI of the DI injector 9a was tested over a range of pressures, from 200 bar in FIG. 7D, 300 bar in FIG. 7C, 400 bar in FIG. 7B and 600 bar in FIG. 7A. Further, for each pressure range (for each figure) the pulse width (i.e., time allotted to the injection of fuel) was varied between 0.5 to 2.0 milliseconds (msec).

The ROI experimental data could be used as input into a GTPower model to enable simulation of the DI fuel system and subsequent engine performance more accurately as shown in FIG. 7F. The simulation results could be used to compare the performance of conventional and OPE engines.

Regarding FIG. 7E, the inventors experimentally measured (i.e., via fuel pump bench testing) the fuel volume injected by DI injector 9a versus the injection time at different fuel pressures from 200 bar to 600 bar. The inventors discovered that for a given injection time, a higher fuel pressure yielded a higher amount of fuel volume. Further, the inventors discovered that because of the inventive, combined configuration of the exemplary, inventive pump 2, rail 8 and fuel injector 9a an increase in fuel pressure led to an increase in the amount of fuel that could be injected into a combustion chamber over a given pulse-width (i.e., time period) as compared to existing engines. Accordingly, the inventors discovered that the inventive OPE 1 that includes an inventive combination of an exemplary, inventive pump 2, rail 8 and fuel injector 9a could burn (or use) fuel faster than existing engines. For example, using 80 cubic millimeters of fuel, a fuel system at lower pressure of 200 bar needs 4.1 milliseconds (ms) to inject fuel into a combustion chamber, while the inventive fuel system (i.e., pump 2, rail 8 and injector 9a) operating at a higher fuel pressure of 600 bar can inject the same amount of fuel into the same combustion chamber in 1.7 milliseconds. Accordingly, the rate of fuel injected into a combustion chamber can be increased by a factor of three (i.e., tripled).

In addition to designing an inventive, shorter DI injector the inventors also discovered that by changing the nozzle of the DI injector 9a the mechanical stresses on the injector 9a could be reduced substantially which improves the durability of the nozzle design, especially at higher fuel pressures).

The claim language that follows below is incorporated herein by reference in expanded form, that is, hierarchically from broadest to narrowest, with each possible combination indicated by the multiple dependent claim references described as a unique standalone embodiment.

While benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

We claim:

1. A method for providing high pressure fuel delivery for an engine comprising:
increasing pressure of a fuel to a range of 150 bar to 1000 bar to yield increased efficiencies and reduced emissions utilizing one or more elements of a high pressure fuel delivery system.

2. The method as in claim 1 further comprising increasing the Reynolds number to provide improved fuel nozzle exit velocity utilizing the one or more elements of the high pressure fuel delivery system.

3. The method as in claim 2 further comprising effectively breaking up molecules of the fuel and improving subsequent droplet vaporization and mixing with air to provide a better diffusion burn mixture utilizing the one or more elements of the high pressure fuel delivery system.

4. The method as in claim 2 further comprising (i) completing multiple fuel injection events during an engine cycle utilizing the one or more elements of the high pressure fuel delivery system, and (ii) providing shaped combustion heat releases to optimize combustion noise, durability, NOx versus smoke emissions and torque utilizing the one or more elements of the high pressure fuel delivery system.

5. The method as in claim 4 further comprising increasing the droplet vaporization to enhance mixing with air and combustion and thermal efficiency while avoiding wall wetting as well as reducing emissions utilizing the one or more elements of the high pressure fuel delivery system.

6. The method as in claim 1 wherein the one or more elements comprise at least an electronically controlled, solenoid inlet valve fuel pump configured to regulate fuel flow to meet a fuel rail pressure target and minimize mechanical losses.

7. The method as in claim 6 wherein the pump is configured and sized for an engine with less than 1.5L displacement.

8. The method as in claim 7 wherein the engine comprises an inwardly opposed piston engine.

9. The method as in claim 6 wherein the pump is configured to deliver the fuel at pressures to a fuel rail at or near setpoint pressures without having to overpressure to meet the fuel rail pressure target.

10. The method as in claim 1 wherein the one or more elements comprises (i) an inlet solenoid valve that minimizes the amount of fuel rail pressure overshoot and (ii) a pressure relief valve and a rail pressure sensor that fine tunes the fuel rail pressure.

11. The method as in claim 1 wherein the one or more elements comprises a fuel rail.

12. The method as in claim 11 wherein the fuel rail comprises a hydraulically optimized fuel rail.

13. The method as in claim 12 further comprising minimizing pressure wave dynamics to enable multiple injection events and combustion heat release rates to avoid high combustion noise and assist in meeting smoke and NOx emission targets utilizing the hydraulically optimized fuel rail.

14. The method as in claim 1 further comprising providing heat release shaping utilizing the one or more elements of the high pressure fuel delivery system.

15. The method as in claim 1 wherein the one or more elements comprises a fuel pump and a fuel rail, and the method further comprises regulating an inlet flow to the fuel pump electronically to limit both fuel flowrate and fuel pressure prior to delivery to a fuel rail.

16. The method as in claim 15 wherein the one or more elements comprises one or more electronic fuel injectors, and wherein the fuel rail is configured to provide a pressure buffer with respect to one or more electronic fuel injectors to enable multiple injections to improve a fuel injection process and overall combustion performance of the engine.

17. A system for providing high pressure fuel delivery for an engine comprising one or more elements, the one or more elements increasing the pressure of a fuel to a range of 2 bar to 1000 bar in order to yield increased efficiencies and reduced emissions.

18. The system as in claim 17 wherein the one or more elements comprises (i) an inlet solenoid valve that minimizes the amount of fuel rail pressure overshoot and (ii) a pressure relief valve and a rail pressure sensor that fine tunes the fuel rail pressure.

19. The system as in claim 17 wherein the one or more elements comprises a hydraulically optimized fuel rail configured to minimize pressure wave dynamics to enable multiple injection events and combustion heat release rates to avoid high combustion noise and assist in meeting smoke and NOx emission targets.

20. The system as in claim 19 wherein the one or more elements further comprises a fuel pump and one or more electronic fuel injectors, and wherein the fuel rail is further configured to provide a pressure buffer with respect to the one or more electronic fuel injectors to enable multiple injections to improve a fuel injection process and overall combustion performance of the engine.
